(19) United States
(12) Patent Application Publication
(10) Pub. No.: US 2009/0077030 A1
(43) Pub. Date: Mar. 19, 2009

(54) CAMERA UNIT AND METHOD FOR INSERTING COMMENTS TO DIGITAL PICTURES AUTOMATICALLY

(75) Inventor: KAN-JU LEE, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/964,775

(22) Filed: Dec. 27, 2007

(30) Foreign Application Priority Data
Sep. 13, 2007 (CN) 200710201678.6

(51) Int. Cl. G06F 17/30; G06F 7/00; G06F 3/048

(52) U.S. Cl. 707/3; 707/10; 715/810; 707/E17.031; 707/E17.112

(57) ABSTRACT

A method for inserting comments on digital pictures automatically is provided. The method includes: selecting a mode of inserting comments to a digital picture; transmitting the digital picture to Web sites, wherein the Web sites provide a plurality of web pages that contain different kinds of images; searching for one or more similar images corresponding to the digital picture in the web pages according to characteristics of the digital picture, and obtaining URLs of the web pages; accessing the web pages according to the URLs, and obtaining key words; searching for related contents from the web pages according to the key words; receiving the searched contents, and displaying the searched contents as a plurality of selectable text strings; choosing available strings from the selectable text strings as comments of the digital picture; and inserting the comments to the digital picture. A related camera unit is also provided.

### BACKGROUND OF THE INVENTION

1. Field of the Invention

The present invention generally relates to image interpreted technology, particularly relates to a camera unit and a method for inserting comments to digital pictures automatically.

2. Description of Related Art

People usually like to take pictures of beautiful sceneries or architectures using a digital camera when they travel to a scenic spot. For example, if a traveler goes to America, she or he would like to take a picture of the Statue of Liberty when she or he sees the Statue of Liberty. Meanwhile, she or he would like to know the information about the Status of Liberty, such as the height, construction period, and history about the Status of Liberty. For another example, if a visitor goes to a zoo or an arboretum, she or he may take pictures of a rare animal or the plant when she or he sees the rare animal or plant. At the same time, she or he may want to know the information of the animal or the plant, such as a name and a habitat of the animal or the plant. However, there is no information about where the sceneries are, or what the architectures are, and other related information about the sceneries or the architecture in the pictures taken by the traveler.

What is need, therefore, is a camera unit and method for inserting comments to pictures, which can automatically interpret the contents of the pictures by inserting the comments about the contents to the pictures.

### SUMMARY OF THE INVENTION

A preferred embodiment provides a camera unit for inserting comments to digital pictures automatically. The camera unit includes: a mode selecting module configured for selecting a mode of inserting comments to a digital picture; a transmitting module configured for transmitting the digital picture to Web sites via the Internet, wherein the Web sites provide a plurality of web pages that contain different kinds of images; an image searching module configured for searching for one or more similar images corresponding to the digital picture in the web pages according to characteristics of the digital picture, and obtaining Uniform Resource Locators (URLs) of the web pages; a key word obtaining module configured for accessing the web pages according to the URLs, and obtaining key words which appear most frequently on the web pages; a content searching module configured for searching for related contents from the web pages according to the key words; a receiving module configured for receiving the searched contents from the web pages, and displaying the searched contents as a plurality of selectable text strings, wherein the selectable text strings can be chosen as comments of the digital picture; and an inserting module configured for automatically inserting the comments to the digital picture.

Another preferred embodiment provides a method for inserting comments to digital pictures automatically. The method includes steps of: selecting a mode of inserting comments to a digital picture; transmitting the digital picture to Web sites via the Internet, wherein the Web sites provide a plurality of web pages that contain different kinds of images; searching for one or more similar images corresponding to the digital picture in the web pages according to characteristics of the digital picture, and obtaining Uniform Resource Locators (URLs) of the web pages; accessing the web pages according to the URLs, and obtaining key words which appear most frequently on the web pages; searching for related contents from the web pages according to the key words; receiving the searched contents from the web pages, and displaying the searched contents as a plurality of selectable text strings; choosing available strings from the selectable text strings as comments of the digital picture; and inserting the comments to the digital picture.

Other advantages and novel features of the present invention will become more apparent from the following detailed description of preferred embodiment when taken in conjunction with the accompanying drawings.

### BRIEF DESCRIPTION OF THE DRAWINGS

FIG. 1 is a block diagram of function modules of a camera unit for inserting comments to digital pictures automatically in accordance with a preferred embodiment; and

FIG. 2 is a flowchart illustrating a method for inserting comments to digital pictures automatically in accordance with a preferred embodiment.

### DETAILED DESCRIPTION OF THE INVENTION

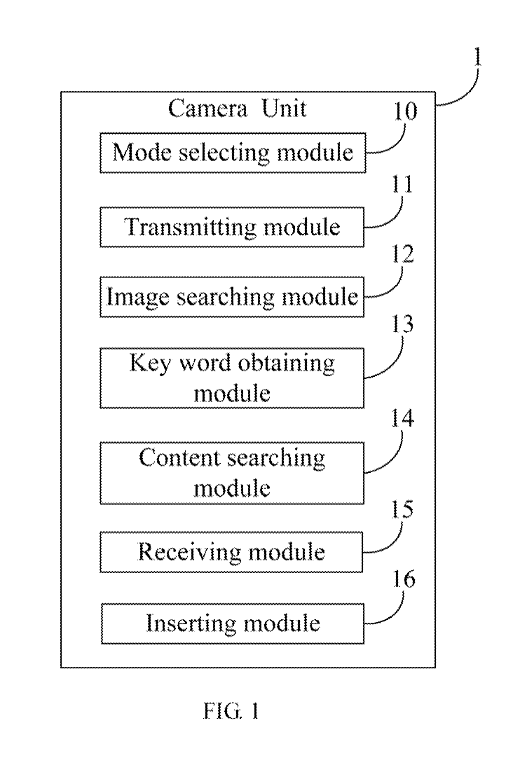

FIG. 1 is a block diagram of function modules of a camera unit 1 for inserting comments to digital pictures automatically in accordance with a preferred embodiment. The camera unit 1 may be installed in a digital camera, a mobile telephone, or any other suitable digital devices that can take pictures. In the preferred embodiment, the camera unit 1 is installed in a digital camera, in order to briefly describe the invention. The digital camera is connected to the Internet through a cable or by wireless when a user takes a picture using the digital camera.

The camera unit 1 herein includes a plurality of software function modules, which mainly are a mode selecting module 10, a transmitting module 11, an image searching module 12, a key word obtaining module 13, a content searching module 14, a receiving module 15, and an inserting module 16.

The mode selecting module 10 is mainly configured for selecting a mode of inserting comments to a digital picture after taking the digital picture by a user.

The transmitting module 11 is mainly configured for transmitting the digital picture to Web sites via the Internet. The Web sites may provide a plurality of web pages that contain different kinds of images, such as “Baidu” and “Google” etc.

The image searching module 12 is mainly configured for searching for one or more images corresponding to the digital picture (hereinafter “the similar images”) in the web pages according to characteristics of the digital picture. The characters may include figures, colors or other factors of image in the digital picture. Furthermore, the image searching module 12 is configured for obtaining Uniform Resource Locators (URLs) of the web pages that contain the similar images.

The key word obtaining module 13 is mainly configured for accessing the web pages according to the URLs, and obtaining key words which appear most frequently on the web pages.

The content searching module 14 is mainly configured for searching for related contents from the web pages according to the key words. The contents may include a plurality of articles or materials which include the key words.

The receiving module 15 is mainly configured for receiving the searched contents from the web pages, and displaying the searched contents as a plurality of selectable text strings on a display of the digital camera. The user can select available strings from the selectable text strings as comments of the digital picture.

The inserting module 16 is mainly configured for automatically inserting the comments to the digital picture.

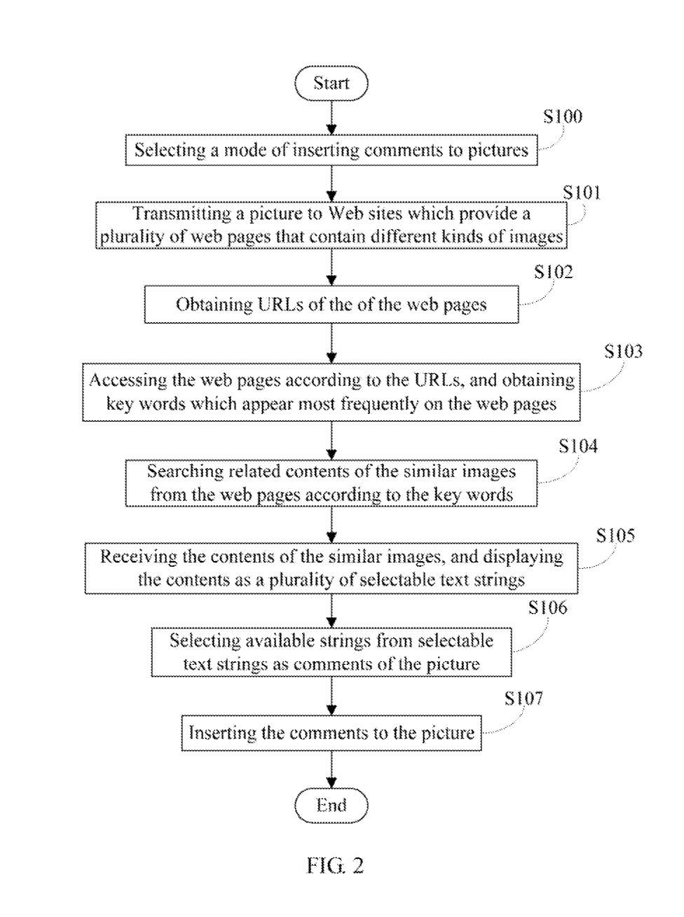

FIG. 2 is a flowchart illustrating a method for inserting comments to digital pictures automatically in accordance with a preferred embodiment.

In step S100, the user selects a mode of inserting comments to a digital picture through the mode selecting module 10 after taking the digital picture.

In step S101, the transmitting module 11 transmits the digital picture to Web sites via the Internet. The Web sites may provide a plurality of web pages that contain different kinds of images, such as “Baidu” and “Google” etc.

In step S102, the image searching module 12 searches for one or more similar images corresponding to the digital picture in the web pages according to characteristics of the digital picture, and obtains URLs of the web pages that contain the similar images.

In step S103, the key word obtaining module 13 accesses the web pages according to the URLs, and obtains key words which appear most frequently on the web pages. For example, the key word obtaining module 13 obtains the key words of “the Status of Liberty” from the web pages that contain the similar images.

In step S104, the content searching module 14 searches for related contents from the web pages according to the key words “the Status of Liberty”. The contents may include a plurality of articles or materials that include the key words “the Status of Liberty”.

In step S105, the receiving module 15 receives the searched contents from the web pages, and displays the searched contents as a plurality of selectable text strings on a display of the digital camera.

In step S106, the user selects available strings from the selectable text strings as comments of the digital picture.

In step S107, the inserting module 16 automatically inserts the comments to the digital picture.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A camera unit for inserting comments to digital pictures automatically, the camera unit comprising:
a mode selecting module configured for selecting a mode of inserting comments to a digital picture;
a transmitting module configured for transmitting the digital picture to Web sites via the Internet, wherein the Web sites provide a plurality of web pages that contain different kinds of images;
an image searching module configured for searching for one or more similar images corresponding to the digital picture in the web pages according to characteristics of the digital picture, and obtaining Uniform Resource Locators (URLs) of the web pages;
a key word obtaining module configured for accessing the web pages according to the URLs, and obtaining key words which appear most frequently on the web pages;
a content searching module configured for searching for related contents from the web pages according to the key words;
a receiving module configured for receiving the searched contents from the web pages, and displaying the searched contents as a plurality of selectable text strings, wherein the selectable text strings can be chosen as comments of the digital picture; and
an inserting module configured for automatically inserting the comments to the digital picture.

2. The camera unit as described in claim 1, wherein the characteristics of the digital picture comprise figures and colors of image in the digital picture.

3. An electronic method for inserting comments to digital pictures automatically, the method comprising steps of:
selecting a mode of inserting comments to a digital picture;
transmitting the digital picture to Web sites via the Internet, wherein the Web sites provide a plurality of web pages that contain different kinds of images;
searching for one or more similar images corresponding to the digital picture in the web pages according to characteristics of the digital picture, and obtaining Uniform Resource Locators (URLs) of the web pages;
accessing the web pages according to the URLs, and obtaining key words which appear most frequently on the web pages;
searching for related contents from the web pages according to the key words;
receiving the searched contents from the web pages, and displaying the searched contents as a plurality of selectable text strings;
choosing available strings from the selectable text strings as comments of the digital picture; and
inserting the comments to the digital picture.

4. The method as described in claim 3, wherein the characteristics of the digital picture comprise figures and colors of image in the digital picture.

5. An electronic method for automatically inserting comments to digital pictures taken by a camera unit, the method comprising steps of:
selecting a mode of inserting comments to a digital picture;
searching for one or more similar images corresponding to the digital picture in web pages according to characteristics of the digital picture, and obtaining Uniform Resource Locators (URLs) of the web pages that contain the similar images;
accessing the web pages according to the URLs;
obtaining related contents of the digital picture as a plurality of selectable text strings from the web pages according to key words which appear most frequently on the web pages;
choosing for available strings from the selectable text strings as comments of the digital picture; and
inserting the comments to the digital picture.

6. The method as described in claim 5, further comprising a step of transmitting the digital picture to Web sites through the Internet, wherein the Web sites provide the web pages that contain the similar images.

7. The method as described in claim 5, further comprising steps of:
receiving the searched contents from the web pages; and
displaying the contents as a plurality of selectable text strings on a display of the camera unit for a user to select the available strings.

8. The method as described in claim 5, wherein the characteristics of the digital picture comprise figures and colors of image in the digital picture.
